(19) United States
(12) Patent Application Publication
(10) Pub. No.: US 2023/0249009 A1
(43) Pub. Date: Aug. 10, 2023

(54) Oxygen Mask Assembly

(71) Applicant: Salvador Silva, Anaheim, CA (US)

(72) Inventor: Salvador Silva, Anaheim, CA (US)

(21) Appl. No.: 17/666,688

(22) Filed: Feb. 8, 2022

(51) Int. Cl. A62B 18/00; A62B 18/08; A62B 18/10; A62B 23/02; A41D 13/11

(52) U.S. Cl. CPC A62B 18/003; A62B 18/084; A62B 18/10; A62B 23/025; A41D 13/11

(57) ABSTRACT

An oxygen mask assembly for assisting a user with breathing while wearing a mask includes a mask is wearable on a user's face such that the mask covers the user's mouth and nose. An oxygen tube extends through the mask to deliver oxygen to the user for breathing when the mask is being worn. An exhale valve is fluidly integrated into the mask and the exhale valve has a single direction of flow. In this way the exhale valve facilitates air exhaled by the user to pass through the exhale valve and inhibit air inhaled by the user from passing through the exhale valve. An oxygen reservoir containing gaseous oxygen is provided and the oxygen tube is fluidly coupled to the oxygen tank to deliver the gaseous oxygen to the user for breathing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to mask devices and more particularly pertains to a new mask device for enhancing breathing while wearing a protective mask. The device includes a face mask which has a fluid impermeable outer layer and a foraminous inner layer. The device includes an oxygen tube which extends through the mask and an exhale valve that extends through the mask. The oxygen tube is fluidly coupled to an oxygen reservoir for delivering oxygen to the user while the mask is being worn.

### (2) Description of Related Art including information disclosed under 37 CFR 1.97 and 1.98

The prior art relates to mask devices including a face mask which includes a suction catheter that is attached to the face mask. The prior art discloses a face mask device that includes a disinfection chamber for reducing microorganisms. The prior art discloses a face mask that includes an oxygen tube for delivering gaseous oxygen while the face mask is being worn. The prior art discloses a snow burial survival mask which includes an exhale valve and an air pump fluidly coupled to the exhale valve for removing carbon dioxide exhaled by a user that has been buried in snow. The prior art discloses a protective face mask that includes an oxygen hose that can be fluidly coupled to an oxygen source in a public transportation vehicle.

### BRIEF SUMMARY OF THE INVENTION

An embodiment of the disclosure meets the needs presented above by generally comprising a mask is wearable on a user's face such that the mask covers the user's mouth and nose. An oxygen tube extends through the mask to deliver oxygen to the user for breathing when the mask is being worn. An exhale valve is fluidly integrated into the mask and the exhale valve has a single direction of flow. In this way the exhale valve facilitates air exhaled by the user to pass through the exhale valve and inhibit air inhaled by the user from passing through the exhale valve. An oxygen reservoir containing gaseous oxygen is provided and the oxygen tube is fluidly coupled to the oxygen tank to deliver the gaseous oxygen to the user for breathing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a back perspective view of an oxygen mask assembly according to an embodiment of the disclosure.

FIG. 2 is a front view of an embodiment of the disclosure.

FIG. 3 is a back view of an embodiment of the disclosure.

FIG. 4 is a left side view of an embodiment of the disclosure.

FIG. 5 is a cross sectional view taken along line 5-5 of FIG. 2 of an embodiment of the disclosure.

FIG. 5A is an enlarged cross sectional view taken along line 5-5 of FIG. 2 of an embodiment of the disclosure.

FIG. 6 is a perspective view of an alternative embodiment of the disclosure.

FIG. 7 is a left side view of an alternative embodiment of the disclosure.

FIG. 8 is a perspective in-use view of an embodiment of the disclosure.

### DETAILED DESCRIPTION OF THE INVENTION

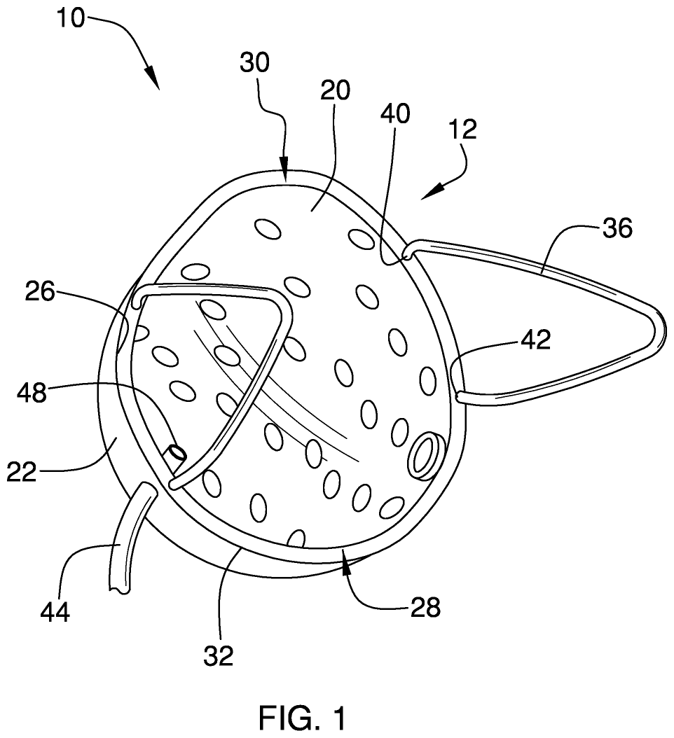

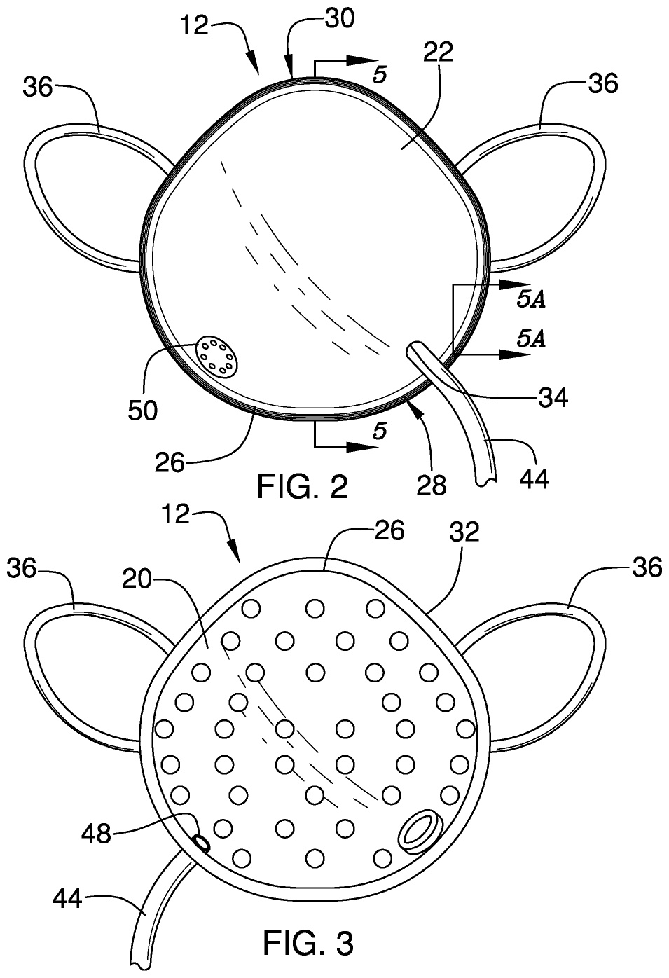

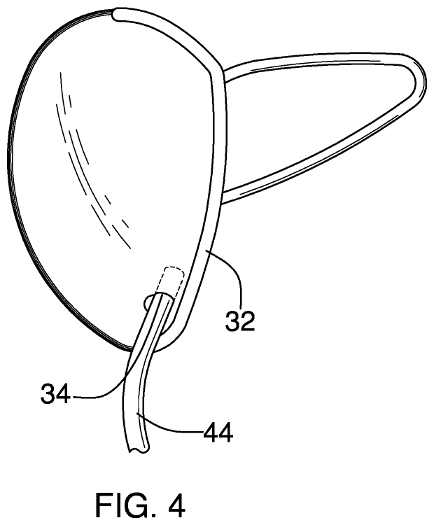

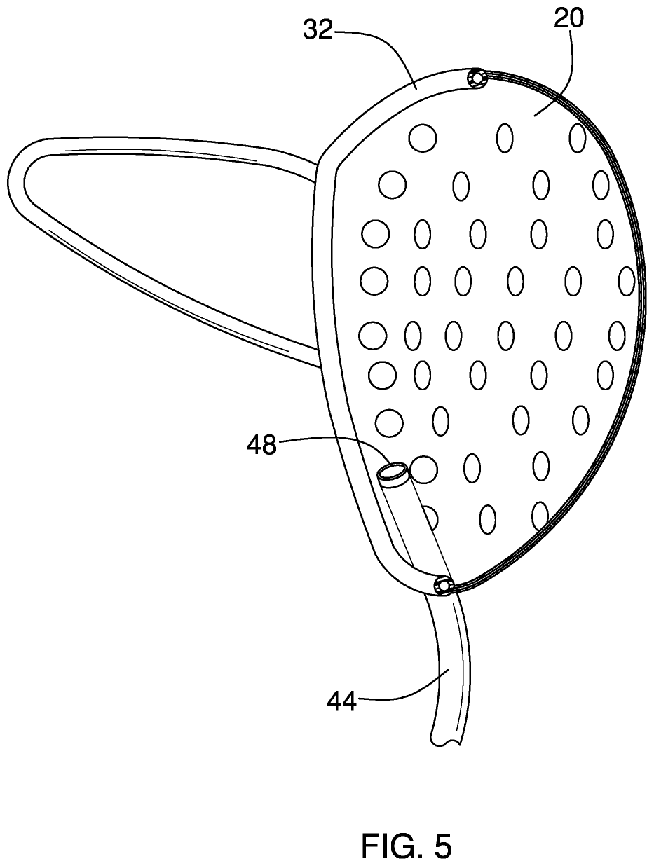

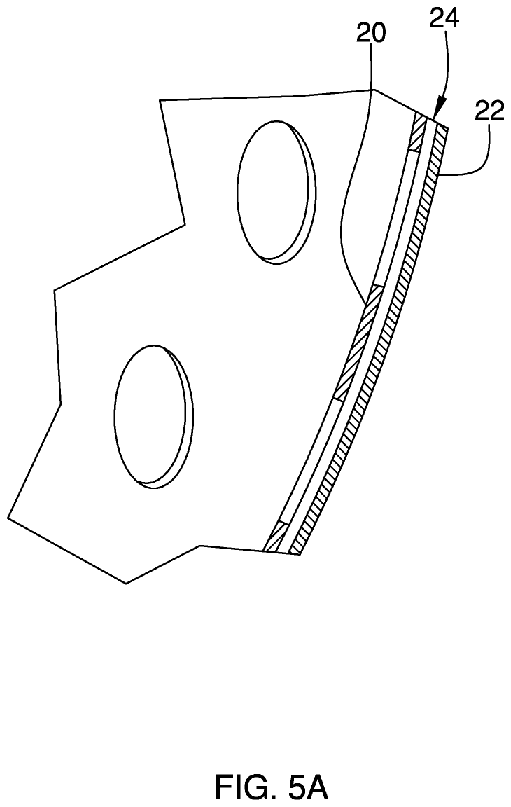

With reference now to the drawings, and in particular to FIGS. 1 through 8 thereof, a new mask device embodying the principles and concepts of an embodiment of the disclosure and generally designated by the reference numeral 10 will be described.

As best illustrated in FIGS. 1 through 8, the oxygen mask assembly 10 generally comprises a mask 12 that is wearable on a user's face 14 such that the mask 12 covers the user's mouth 16 and nose 18. The mask 12 comprises an inner layer 20 and an outer layer 22, and the outer layer 22 is comprised of a fluid impermeable material to inhibit the user from inhaling airborne pathogens and particles. The inner layer 20 is foraminous thereby facilitating the inner layer 20 to ventilate a space 24 between the inner layer 20 and the outer layer 22. The mask 12 has a perimeter edge 26, and each of the inner layer 20 and the outer layer 22 is joined at the perimeter edge 26. Additionally, each of the inner layer 20 and the outer layer 22 is comprised of a translucent material.

The perimeter edge 26 has a lower portion 28 that is rounded and an upper portion 30 that is ovoid such that the perimeter edge 26 defines a pear shape to conform to the shape of the user's face 14. The mask 12 includes a tube 32 which is bonded to the perimeter edge 26 and the tube 32 extends around an entirety of the perimeter edge 26. The tube 32 is comprised of a resiliently compressible material to enhance comfort for the user's face 14 when the mask 12 is worn. The mask 12 has an oxygen hole 34 extending through the inner surface 14 and the outer surface 14, and the oxygen hole 34 is positioned adjacent to the lower portion 28 of the perimeter edge 26.

A pair of ear loops 36 is coupled to the mask 12 and each of the ear loops 36 can be positioned around a respective one of the user's ears 38. Each of the ear loops 36 has a first end 40 and a second end 42, and each of the first end 40 and the second end 42 of each of the ear loops 36 is coupled to the tube 32. The ear loops 36 is positioned on opposite sides of the mask 12 with respect to each other. An oxygen tube 44 extends through the mask 12 to deliver oxygen to the user for breathing when the mask 12 is being worn. The oxygen tube 44 has a primary end 46 and a secondary end 48, and the oxygen tube 44 extends through the oxygen hole 34 has the secondary end 48 is exposed on the mask 12.

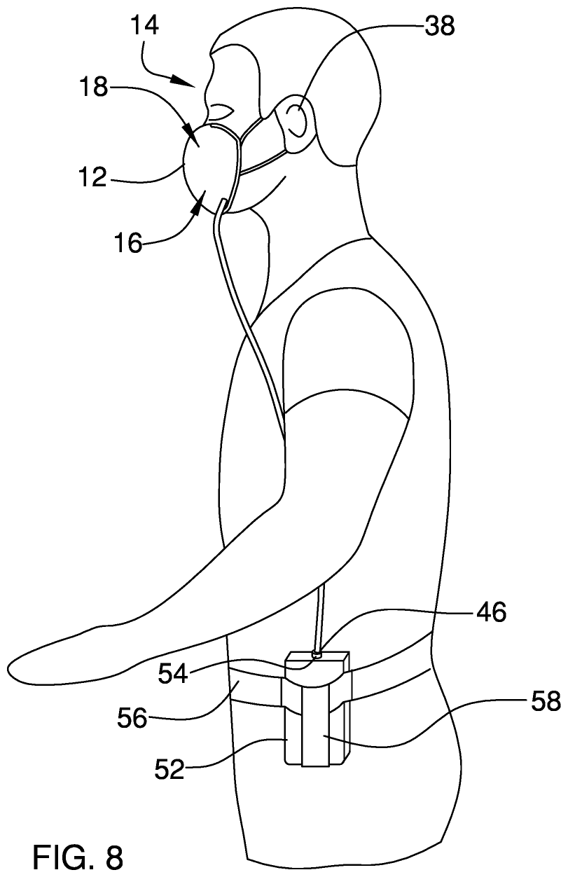

An exhale valve 50 is fluidly integrated into the mask 12 and the exhale valve 50 has a single direction of flow. In this way air exhaled by the user can pass through the exhale valve 50 and inhibit air inhaled by the user from passing through the exhale valve 50. The exhale valve 50 extends through the outer surface 14 and the inner surface 14. The single direction of flow of the exhale valve 50 moves from the inner surface 14 toward the outer surface 14. An oxygen reservoir 52 is provided which contains gaseous oxygen. The oxygen tube 44 is fluidly coupled to the oxygen tank to deliver the gaseous oxygen to the user for breathing. Additionally, the primary end 46 of the oxygen tube 44 is fluidly coupled to an outlet 54 of the oxygen reservoir 52. As is most clearly shown in FIG. 8, a belt 56 is provided which is worn around the user's waist and a holster 58 is integrated into the belt 56. The oxygen reservoir 52 is insertable into the holster 58 for carrying the oxygen reservoir 52 while the mask 12 is being worn.

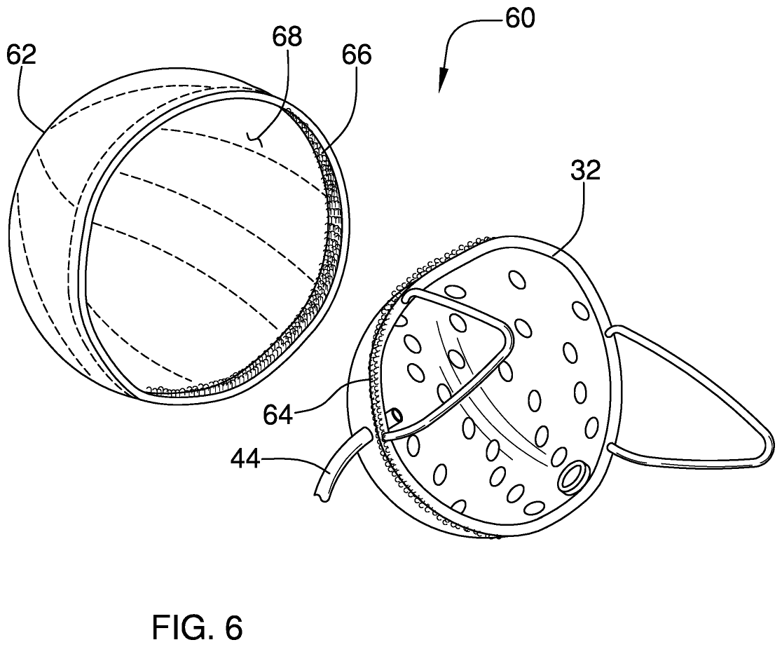

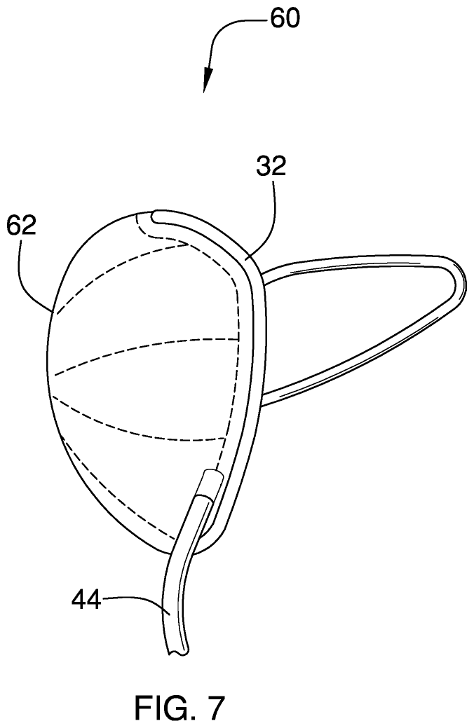

In an alternative embodiment 60 as is most clearly shown in FIGS. 6 and 7, a cover 62 is provided which is attachable to the outer layer 22 of the mask 12, and the cover 62 is comprised of a textile material to protect the outer layer 22. A first mating member 64 is coupled to the outer surface 14 of the mask 12 and the first mating member 64 is coextensive with the perimeter edge 26 of the mask 12. A second mating member 66 is coupled to an inside surface 68 of the cover 62 and the second mating member 66 is matable to the first mating member 64 when the cover 62 is positioned over the mask 12 for retaining the cover 62 on the mask 12. Each of the first mating member 64 and the second mating member 66 may comprise a hook and loop fastener or the like.

In use, the mask 12 is worn on the user's face 14 when the user needs to adhere to Covid-19 related masking requirements. The oxygen tube 44 delivers oxygen to the user while the user is wearing the mask 12. In this way the user can breathe more easily as compared to wearing cloth mask or surgical mask. The cover 62 can be positioned over the mask 12 for enhanced protection against airborne particles and pathogens.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An oxygen mask assembly for protecting a user from airborne transmission of infectious diseases, said assembly comprising:
a mask being wearable on a user's face such that said mask covers the user's mouth and nose, said mask comprising an inner layer and an outer layer, said outer layer being comprised of a fluid impermeable material wherein said outer layer is configured to inhibit the user from inhaling airborne pathogens and particles, said inner layer being foraminous thereby facilitating said inner layer to ventilate a space between said inner layer and said outer layer;
a pair of ear loops, each of said ear loops being coupled to said mask wherein each of said ear loops is configured to be positioned around a respective one of the user's ears;
an oxygen tube extending through said mask wherein said oxygen tube is configured to deliver oxygen to the user for breathing when said mask is being worn;
an exhale valve being fluidly integrated into said mask, said exhale valve having a single direction of flow wherein said exhale valve is configured to facilitate air exhaled by the user to pass through said exhale valve and to inhibit air inhaled by the user from passing through said exhale valve; and
an oxygen reservoir containing gaseous oxygen, said oxygen tube being fluidly coupled to said oxygen tank wherein said oxygen tank is configured to deliver the gaseous oxygen to the user for breathing.

2. The assembly according to claim 1, wherein:
said mask has a perimeter edge, each of said inner layer and said outer layer being joined at said perimeter edge, said perimeter edge having a lower portion being rounded and an upper portion being ovoid such that said perimeter edge defines a pear shape wherein said mask is configured to conform to the shape of the user's face;
said mask has a tube being bonded to said perimeter edge, said tube extending around an entirety of said perimeter edge, said tube being comprised of a resiliently compressible material wherein said tube is configured to enhance comfort for the user's face when said mask is worn; and
said mask has an oxygen hole extending through said inner surface and said outer surface, said oxygen hole being positioned adjacent to said lower portion of said perimeter edge.

3. The assembly according to claim 2, wherein said oxygen tube has a primary end and a secondary end, said oxygen tube extending through said oxygen hole having said secondary end being exposed on said mask.

4. The assembly according to claim 2, wherein said exhale valve extends through said outer surface and said inner surface, said single direction of flow of said exhale valve moving from said inner surface toward said outer surface.

5. The assembly according to claim 3, wherein said primary end of said oxygen tube being fluidly coupled to an outlet of said oxygen reservoir.

6. An oxygen mask assembly for protecting a user from airborne transmission of infectious diseases, said assembly comprising:
a mask being wearable on a user's face such that said mask covers the user's mouth and nose, said mask comprising an inner layer and an outer layer, said outer layer being comprised of a fluid impermeable material wherein said outer layer is configured to inhibit the user from inhaling airborne pathogens and particles, said inner layer being foraminous thereby facilitating said inner layer to ventilate a space between said inner layer and said outer layer, said mask having a perimeter edge, each of said inner layer and said outer layer being joined at said perimeter edge, said perimeter edge having a lower portion being rounded and an upper portion being ovoid such that said perimeter edge defines a pear shape wherein said mask is configured to conform to the shape of the user's face, said mask having a tube being bonded to said perimeter edge, said tube extending around an entirety of said perimeter edge, said tube being comprised of a resiliently compressible material wherein said tube is configured to enhance comfort for the user's face when said mask is worn, said mask having an oxygen hole extending through said inner surface and said outer surface, said oxygen hole being positioned adjacent to said lower portion of said perimeter edge;
a pair of ear loops, each of said ear loops being coupled to said mask wherein each of said ear loops is configured to be positioned around a respective one of the user's ears, each of said ear loops having a first end and a second end, each of said first end and said second end of each of said ear loops being coupled to said tube, said ear loops being positioned on opposite sides of said mask with respect to each other;
an oxygen tube extending through said mask wherein said oxygen tube is configured to deliver oxygen to the user for breathing when said mask is being worn, said oxygen tube having a primary end and a secondary end, said oxygen tube extending through said oxygen hole having said secondary end being exposed on said mask;
an exhale valve being fluidly integrated into said mask, said exhale valve having a single direction of flow wherein said exhale valve is configured to facilitate air exhaled by the user to pass through said exhale valve and to inhibit air inhaled by the user from passing through said exhale valve, said exhale valve extending through said outer surface and said inner surface, said single direction of flow of said exhale valve moving from said inner surface toward said outer surface; and
an oxygen reservoir containing gaseous oxygen, said oxygen tube being fluidly coupled to said oxygen tank wherein said oxygen tank is configured to deliver the gaseous oxygen to the user for breathing, said primary end of said oxygen tube being fluidly coupled to an outlet of said oxygen reservoir.

7. The assembly according to claim 6, further comprising a cover being attachable to said outer layer of said mask, said cover being comprised of a textile material to protect said outer layer.

8. The assembly according to claim 7, further comprising:
a first mating member being coupled to said outer surface of said mask, said first mating member being coextensive with said perimeter edge of said mask; and
a second mating member being coupled to an inside surface of said cover, said second mating member being matable to said first mating member when said cover is positioned over said mask for retaining said cover on said mask.
